(19) United States
(12) Patent Application Publication
(10) Pub. No.: US 2023/0416651 A1
(43) Pub. Date: Dec. 28, 2023

(54) COMPOSITION

(71) Applicant: RECKITT BENCKISER FINISH B.V., Hoofddorp (NL)

(72) Inventors: Alias Younis AL-BAYATI, Heidelberg (DE); Torsten ROTH, Heidelberg (DE); Itahisa SUAREZ, Heidelberg (DE); Alexander WINK, Heidelberg (DE)

(21) Appl. No.: 18/252,200

(22) PCT Filed: Nov. 10, 2021
(86) PCT No.: PCT/EP2021/081216

§ 371 Date: May 9, 2023

(30) Foreign Application Priority Data
Nov. 17, 2020 (GB) 2018029.5

(51) Int. Cl. C11D 3/39; C11D 11/00; C11D 17/04; C11D 3/43

(52) U.S. Cl. CPC C11D 3/3932; C11D 11/0023; C11D 17/045; C11D 3/43; C11D 3/3942

(57) ABSTRACT

A liquid detergent composition comprising manganese 1,4,7-triazacyclononane (MnTACN) and derivatives thereof and a polar solvent, wherein the composition is contained in a water-soluble film.

The present disclosure relates to automatic dishwashing compositions, and the method of manufacture and the use of the same.

Detergents, in particular automatic dishwashing products, that have a smooth, continuous visual appearance, such as transparent liquids, are typically more aesthetically appealing to consumers than more heterogeneous compositions in granular, powder or tablet form. Liquids are also faster-dissolving in use. Multi-compartment water-soluble automatic dishwashing detergent pouches comprising one or more forms of detergent (e.g. solids, liquids and/or gels) are becoming more and more popular and are particularly attractive to consumers as they give the appearance of highly concentrated detergents with compartments each serving a different purpose.

In order to achieve a high level of cleaning and shine performance, automatic dishwashing products need to contain significant quantities of active ingredients such as builders, co-builders, surfactants, polymers, enzymes, bleaching compounds and sometimes anti-corrosion or glass-protecting agents. In a multi-compartment pouch that comprises a liquid compartment at least some of the actives need to be in the liquid phase to achieve the required performance of the multi-benefit product. Furthermore, a greater degree of separation of active components can be beneficial for the stability, compatibility and activity of the active ingredients.

It is also desirous for such a liquid formulation to be transparent in order to be both aesthetically pleasing and to convey purity and efficacy. Such a composition should also have the ability to be dyed in order to improve the appearance of both the composition and any wider detergent product that it may be incorporated into.

It is therefore desired to have a compartment as part of a water-soluble dishwashing multi-compartment pouch that contains a bleach catalyst(s) in a liquid composition. Such pouches are typically made from polyvinyl alcohol (PVOH). Such a composition would provide an enhanced bleaching performance due to increased availability and consistent dosing, as well as providing a compartment that has a specific function of boosting performance on bleachable stains.

The manganese 1,4,7-Triazacyclononane complex (MnTACN) was originally designed as a model system for metallo-proteins and in 1994 the molecule was adopted as a bleach catalyst in laundry and automatic dishwashing formulations and enabled the low temperature removal of bleachable stains and starch residues as well as anti-tarnishing benefits. Despite this widespread use and countless academic studies, the stability of the complex in the presence of standard detergent ingredients is still a major challenge for formulators in the technical field.

Previous attempts to obtain a liquid, transparent composition comprising MnTACN suffered multiple drawbacks such as a high water content which resulted in PVOH plasticisation/degradation over time; the combination of MnTACN and an alkoxylated fatty alcohol surfactant resulted in MnTACN decomposition in storage; and/or the necessity to use enabling solvents and formulation aids to ensure a homogeneous composition which does not improve the technical performance.

There is therefore a technical need to develop a stable liquid formulation comprising MnTACN to overcome current stability and aesthetic limitations that is compatible with PVOH. Furthermore, there are difficulties incorporating MnTACN in the wider formulation due to its inherent incompatibility with strong oxidising agents such as sodium percarbonate, surfactants (alkoxylated fatty alcohols) and certain solvents (PEGS), which result in unappealing discolorations, precipitation and concomitant loss of bleach activity.

The present invention addresses the above technical problems. In a first aspect of the present invention there is provided a liquid detergent composition comprising manganese 1,4,7-triazacyclononane (MnTACN) and derivatives thereof and a polar solvent, wherein the composition is contained in a water-soluble film.

It was found that certain polar liquids are suitable solvents for dissolving bleach catalysts and related compounds, resulting in transparent liquids with bleach-improving benefits that are also suitable for PVOH containers.

By derivatives of MnTACN, we hereby include all ligands that have a 1,4,7-triazacyclononane backbone, such as 1,4,7-Trimethyl-1,4,7-triazacyclononane or the bridged ligand 1,2-bis(octahydro-4,7-dimethyl-1H-1,4,7-triazonine-1-yl)ethane (TMEM).

Advantageously, the polar solvent is aprotic. It has surprisingly been found that aprotic polar solvents are less likely to attack water-soluble films, such as PVOH, and thus are significantly more stable.

Preferably the composition contains less than 10% by weight water, such as less than 5%, less than 3%, less than 2%, or contains less than 1% by weight of water. Advantageously, the composition is essentially free of water or even contains 0% water.

Advantageously, the polar solvent is selected from one or more of N-Acetylcaprolactam, propylenecarbonate, γ-valerolactone, cyrene, acetonitrile, ε-caprolactone, ε-caprolactam, dimethylsuphoxide, ethylene carbonate, β-butyrolactone, γ-butyrolactone, N-methylpyrrolidone, methyl sulpholane, sulpholane, 2,3-butylene carbonate, nitromethane, 2-pyrrolidone, butadiene sulfone, cyclobutanone, cyclopentanone, ethylene sulphite, glycerol carbonate acetate, N-acetyl piperidine, and/or N-acetyl pyrrolidone. More preferably the polar solvent is selected from one or more of N-Acetylcaprolactam (1-acetylazepan-2-one), propylenecarbonate (4-Methyl-1,3-dioxolan-2-one), valerolactone (γ-valerolactone, 5-Methyloxolan-2-one; or δ-Valerolactone, tetrahydro-2H-pyran-2-one) and/or cyrene ((1R)-7,8-Dioxabicyclo[3.2.1]octan-2-one).

Such solvents are believed to aid the stain removal properties of the detergent composition as well as solubilising the bleach catalyst without interacting with water-soluble films.

N-Acetylcaprolactam is particularly preferred and was surprisingly found to be a polar enough solvent to dissolve ionic metal complexes such as MnTACN at a high capacity and is itself a potent bleach activator. Thus, N-Acetylcaprolactam serves a dual purpose as solvent for the MnTACN and as bleach activator in the cleaning process and so (without sacrificing space for filler solvents) constitutes a more sustainable approach than a purely solvent based system.

Preferably, the MnTACN is present in a concentration of from 0.1 to 30 mg/mL, such as from 1 to 25 mg/mL, preferably from 2 to 20 mg/mL, from 5 to 16 mg/mL, or even from 7 to 12 mg/mL.

Advantageously, the MnTACN is present in an amount of from 0.1 to 5% by weight, such as from 0.2 to 4% by weight, from 0.3 to 3% by weight, from 0.6 to 2% by weight, or even 0.7 to 1.5% by weight.

Preferably the polar solvent(s) is/are present in an amount from 45 to 99.9% by weight, preferably from 70 to 99.5% by weight, such from 80 to 99.2% by weight, or even from 90 to 99.0% by weight.

The composition may comprise N-Acetylcaprolactam and propylenecarbonate in a ratio of from 5:1 to 1:5, such as from 2:1 to 1:2, or even 1.1:1 to 1:1.1, respectively.

Advantageously, the composition further contains one or more of a dye and/or material care agents (such as silver or copper protection agent(s)). The dye and/or material care agent may be present in an amount of from 0.5 to 20% by weight, such as from 1 to 15% by weight, or even from 7 to 13% by weight.

Preferred silver/copper protection agents are benzotriazole (BTA) or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain C1-20 alkyl groups and hydroxyl, thio, phenyl or halogen such as fluorine, chlorine, bromine and iodine. A preferred substituted benzotriazole is tolyltriazole (TTA).

Without wishing to be bound by theory, it is believed that the addition of a nitrogen donor ligand, such as BTA, helps to stabilise the MnTACN against degradation in solution.

Preferably, the composition contains less than 1% by weight, such as from 0 to 0.9% by weight, or even 0% by weight, of bleaching agents (such as percarbonate), polyglycols, builders (such as methyl glycine diacetic acid), enzymes, and/or surfactants (such as alkoxylated fatty alcohols).

Preferably, the composition is transparent. The term transparent liquid means that it is possible to read Arial size 5 text through the liquid with a 1 cm path length.

In an embodiment, the composition according to the invention is contained in a water-soluble film, preferably a polyvinyl alcohol (PVOH) film. The composition, excluding any water-soluble film, preferably weighs from 0.1 to 3 g, such as from 0.15 to 1 g, from 0.2 to 0.7 g, or even 0.2 to 0.65 g. Preferably, the product is in a unit dose or monodose form. In other words, the product preferably comprises the composition in combination with other compositions in the quantity required for a single wash cycle of a machine dishwasher. The terms monodose and unit dose may be used interchangeably throughout this disclosure. The composition is preferably contained within a multi-chamber monodose detergent.

Advantageously, the composition is stable in a water-soluble film. By the term ‘water-soluble’ or ‘water-dispersible’ container as used herein, it is meant a package which at least partially dissolves in water or disperses in water at 20° C. within 10 minutes to allow for egress of the contents of the package into the surrounding water.

By stable we mean that the composition can be stored for two weeks at 5° C. with no change in colour, precipitation, deflation of the compartment or visible plasticisation.

In a second aspect of the invention, there is provided a method of making a composition according to the invention.

In a third aspect of the invention, there is provided the use of a composition according to the present invention.

It is intended that all described features can be combined with one or more other features in any combination. All percentages are by weight unless otherwise specified. All references to ‘between’ and percentages are intended to include the stated end points and so are equivalent to ‘from’ and ‘to’.

The invention is described in the following non-limiting Examples.

### EXAMPLES

Dissolution Trials

A range of solvents and solvent mixtures were tested to assess their ability to dissolve MnTACN. The solvent compositions as defined in Table 1 were tested by combining 1% by weight MnTACN solution (concentration of 10 mg/mL) with 99% by weight of the solvent compositions.

Solubility of the red-brown MnTACN complex is indicated by homogeneous colourisation of the solvent and the results are shown in Table 1.

TABLE 1
MnTACN Solubility Screening

| | Solvent/Solvent mixture | |
|---|---|---|
| Composition | (99% by weight of composition) | Result |
| 1 | Acetic acid | Complex not sufficiently soluble |
| 2 | 2-Methyl tetrahydrofuran | Complex not soluble |
| 3 | Triethyl 2-acetylcitrate | Complex not sufficiently soluble |
| 4 | Propylene carbonate | Complex soluble |
| 5 | N-Acetylcaprolactam | Complex soluble |
| 6 | N-Acetylcaprolactam:alkoxylated | Complex not sufficiently |
| | fatty alcohol (1:1) | soluble, slightly cloudy |
| 7 | N-Acetylcaprolactam:dipropylene | Complex not sufficiently |
| | glycol (1:1) | soluble, slightly cloudy |
| 8 | N-Acetylcaprolactam:alkyl | Complex not sufficiently |
| | polyglucoside (1:1) | soluble, slightly cloudy |
| 9 | N-Acetylcaprolactam:propylene | Complex soluble |
| | carbonate (1:1) | |
| 10 | y-Valerolactone | Complex soluble |
| 11 | Dimethyl carbonate | Complex not soluble |
| 12 | Cyrene | Complex soluble |
| 13 | Ethyl lactate | Complex not sufficiently |
| | | soluble, slightly cloudy |
| 17 | 2-Hydroxy-N,N-dimethylpropanamide | Complex soluble |
| 18 | 1-methoxy-2-propanol | Complex not sufficiently soluble |
| 19 | Valerolactone + BHT | Complex soluble |

Stability Trials

Storage stability trials were conducted with the candidates that displayed a suitable solubilising properties above.

The stability of the solubilized complex was assessed in a glass vial, with the results shown in Table 2.

TABLE 2
Vial Storage Test

| Composition | 2 week's storage at 5° C. | 2 week's storage at 40° C. |
|---|---|---|
| 4 | No change | No change |
| 5 | No change | No Change |
| 9 | No change | No change |
| 10 | No change | Slight Darkening |
| 12 | No change | Brighter/Lighter |
| 13 | No change | Darkening |
| 17 | No change | No Change |
| 19 | No change | No change |

The solutions were placed in PVOH containers to review stability and check any plasticizing effect of the solvent. The results are shown in Table 3.

TABLE 3
PVOH Storage Test

| Composition | 2 week's storage at 5° C. | 2 week's storage at 40° C. |
|---|---|---|
| 4 | No change | No change |
| 5 | No change | Slight Darkening |
| 9 | No change | Slight Darkening |
| 10 | No change | Deformed |
| 17 | No change | Deflation/Leaking, orange |
| | | discoloration |
| 19 | No change | Yellow discoloration |

There is therefore provided a solvent system that successfully solubilises MnTACN, is stable in a water-soluble film and provides an additional effect on the wider detergent system.

The invention is defined by the claims.

1. A liquid detergent composition comprising manganese 1,4,7-triazacyclononane (MnTACN) and derivatives thereof and a polar solvent, wherein the composition is contained in a water-soluble film.

2. A composition according to claim 1, wherein the polar solvent is aprotic.

3. A composition according to claim 1 or 2, wherein the polar solvent is selected from one or more of N-Acetylcaprolactam, propylenecarbonate, γ-valerolactone, cyrene, acetonitrile, ε-caprolactone, ε-caprolactam, dimethylsuphoxide, ethylene carbonate, β-butyrolactone, γ-butyrolactone, N-methylpyrrolidone, methyl sulpholane, sulpholane, 2,3-butylene carbonate, nitromethane, 2-pyrrolidone, butadiene sulfone, cyclobutanone, cyclopentanone, ethylene sulphite, glycerol carbonate acetate, N-acetyl piperidine, and/or N-acetyl pyrrolidone.

4. A composition according to any of the preceding claims, wherein the MnTACN is present in a concentration of from 0.1 to 30 mg/mL, based on the total volume of the composition.

5. A composition according to any of the preceding claims, wherein the MnTACN is present in an amount of from 0.1 to 5% by weight, based on the total weight of the composition.

6. A composition according to any of the preceding claims, wherein the polar solvent is present in an amount from 45 to 99.9% by weight, preferably from 70 to 99.5% by weight, based on the total weight of the composition.

7. A composition according to any of the preceding claims; wherein the composition further comprises one or more of a dye and/or material care agent(s).

8. A composition according to any of the preceding claims, wherein the composition contains less than 1% by weight of percarbonate.

9. A composition according to any of the preceding claims, wherein the composition contains less than 1% by weight of water.

10. A composition according to any of the preceding claims, wherein the composition is transparent.

11. A composition according to any of the preceding claims, wherein the water-soluble film is a polyvinyl alcohol (PVOH) film.

12. A composition according to any of the preceding claims, wherein the composition weighs from 0.1 to 3 g, preferably from 0.15 to 1 g.

13. A composition according to any of the preceding claims, wherein the composition is contained within a multi-chamber detergent pouch.

14. A method of making a composition according to any of claims 1 to 13.

15. Use of a composition according to any claims 1 to 13 in an automatic dishwashing process.
